(19) United States
(12) Patent Application Publication
(10) Pub. No.: US 2014/0118533 A1
(43) Pub. Date: May 1, 2014

(54) OPERATIONAL STABILITY ENHANCING DEVICE FOR CONSTRUCTION MACHINERY

(71) Applicant: DOOSAN INFRACORE CO., LTD, Incheon (KR)

(72) Inventor: Kyung Yul Chang, Seoul (KR)

(73) Assignee: DOOSAN INFRACORE CO., LTD., Incheon (KR)

(21) Appl. No.: 14/125,467

(22) PCT Filed: Jan. 28, 2013
(86) PCT No.: PCT/KR2013/000659

§ 371 Date: Dec. 11, 2013

(30) Foreign Application Priority Data
Jan. 27, 2012 (KR) 10-2012-0008078
Jan. 30, 2012 (KR) 10-2012-0008763
Dec. 17, 2012 (KR) 10-2012-0147482
Jan. 10, 2013 (KR) 10-2013-0002815

(51) Int. Cl. B60R 1/00

(52) U.S. Cl. CPC B60R 1/00
USPC 348/118

(57) ABSTRACT

According to the present invention, an operational stability enhancing device for construction machinery is provided. The operational stability enhancing device for construction machinery includes: a plurality of cameras configured to capture surrounding images of construction machinery; a plurality of sensors configured to detect an obstacle located in the surrounding area of the construction machinery; a monitor configured to display the surrounding images captured by the plurality of cameras; and a control unit configured to, in a case where a detected object is detected in a surrounding area of a moving path by the sensor, and the detected object is an avoidance processing target, display an image of the captured detected object on a monitor through screen conversion or change the image of the captured detected object so as to be easily recognized by an operator when the construction machines approaches the detected object.

### CROSS-REFERENCE TO RELATED APPLICATION

This application is a Section 371 National Stage application of International Application No. PCT/KR2013/000659, filed Jan. 28, 2013 and published, not in English, as WO2013/112016 on Aug. 1, 2013.

### FIELD OF THE DISCLOSURE

The present disclosure relates to an operational stability enhancing device for construction machinery.

### BACKGROUND OF THE DISCLOSURE

In general, construction machinery, such as an excavator, is constructed such that a lower travelling body and an upper turning body are capable of freely turning. As described above, a case where the upper turning body turns with respect to the lower travelling body or the lower travelling body is reversed is generated while the construction machinery is operated, and in this case, there exists a blind spot which an operator operating the construction machinery in a driver's seat cannot visually see.

Accordingly, since the operator needs to operate the construction machinery while looking into a mirror provided in the upper turning body and the like of the construction machinery, or directly visually seeing a corresponding movement path, there is a problem in deterioration of working efficiency.

Accordingly, in order to solve the aforementioned problem, disclosed is an operational stability enhancing device which allows an obstacle located at a blind spot to be checked through an image captured by a camera by installing the camera at left and right sides or a rear side of an upper turning body.

That is, an around view monitoring (AVM) system, in which each camera is installed at a front side, left and right sides, and a rear side of a driver's cabin of construction machinery, and images of corresponding directions captured by the respective cameras are displayed on a screen, or synthesized into one image to be displayed, is applied to the operational stability enhancing device.

However, according to an image display device for construction machinery to which the AVM system in the related art is applied, a camera is installed only at a front side of a driver's cabin of the construction machinery, that is, a left-front side of the construction machinery, so that it is impossible to accurately recognize position information on an obstacle, such as electric wires and a telephone pole, present at an upper side of a right-front side, which is a blind spot hidden by a boom, a bucket, and the like, of the construction machinery, thereby causing a problem in that a negligence accident is generated when a boom is up or a turning body is turned to a right side.

Further, in the operational stability enhancing device for construction machinery in the related art, since only an image according to a movement route of construction machinery is simply displayed, there is a problem in that an operator needs to cumbersomely check each monitor, and further, since an operator needs to depend on a feeling about a distance from an obstacle checked through the monitor, there is a problem in that a negligence accident is generated in a case where the operator fails to accurately recognize information about a distance from the obstacle.

The discussion above is merely provided for general background information and is not intended to be used as an aid in determining the scope of the claimed subject matter.

### SUMMARY

This summary and the abstract are provided to introduce a selection of concepts in a simplified form that are further described below in the Detailed Description. The summary and the abstract are not intended to identify key features or essential features of the claimed subject matter, nor are they intended to be used as an aid in determining the scope of the claimed subject matter.

Accordingly, a first exemplary embodiment of the present disclosure is suggested to solve the aforementioned problems, and an object thereof is to provide an image display device for construction machinery, which may further capture an image for a right-front-upper side of a turning body, and then selectively display the image for the right-front-upper side together with an AVM screen region when a boom is up or the turning body turns to a right side, in construction machinery to which an AVM system is applied.

Another object thereof is to provide an operational stability enhancing device for construction machinery, which is capable of enhancing stability according to an operation state of the construction machinery by making the construction machinery be automatically controlled or moved in order to prevent the construction machinery from approaching a detected object during an operation in a case of an avoidance processing target.

However, an object of the present disclosure is not limited to the aforementioned objects, and those skilled in the art will clearly understand unmentioned other objects through the following description.

In order to achieve the above objects, according to the present disclosure, an operational stability enhancing device for construction machinery is provided. The operational stability enhancing device for construction machinery may include: a plurality of cameras configured to capture surrounding images of construction machinery; a plurality of sensors configured to detect an obstacle located in a surrounding area of the construction machinery; a monitor configured to display the surrounding images of the construction machinery captured by the plurality of cameras; an electronic hydraulic pressure control valve configured to output an output flow rate of a corresponding hydraulic system driving unit so as to correspond to a manipulation signal of a user manipulation unit of the construction machinery; and a control unit configured to, in a case where a detected object is detected in the surrounding area of a moving path by the sensor, and the detected object is an avoidance processing target, delay or stop an operation command for the manipulation signal by automatically controlling the electronic hydraulic pressure control valve when the construction machinery approaches the detected object.

Further, in order to achieve the above objects, according to the present disclosure, an operational stability enhancing device for construction machinery is provided. The device for enhancing operational stability for construction machinery may include: a plurality of cameras configured to capture surrounding images of construction machinery; a plurality of sensors configured to detect an obstacle located in a surrounding area of the construction machinery; a monitor configured to display the surrounding images of the construction machinery captured by the plurality of cameras; an electronic hydraulic pressure control valve configured to control an output flow rate of a corresponding hydraulic system driving unit so as to correspond to a manipulation signal of a user manipulation unit of the construction machinery; and a control unit configured to, in a case where a detected object is detected in the surrounding area of a moving path by the sensor, and the detected object is an avoidance processing target, display an image of the captured detected object on a monitor 60 through screen conversion or change the image of the captured detected object so as to be easily recognized by an operator when the construction machines approaches the detected object.

A method of changing the image of the captured detected object includes a method of making a corresponding image flicker, a method of displaying a screen image with a different color, and a method of displaying the corresponding image on the entire monitor or displaying the corresponding image at a center portion of the monitor in a pop-up form in a case where the corresponding image is displayed on one screen among the plurality of screens, which are methods capable of attracting an attention of an operator.

The device for enhancing operational stability for the construction machinery may further include a scanner configured to scan surrounding information of the construction machinery. The scanner may be installed at an upper portion of the construction machinery to 3D scan obstructions scattered in an irregular ground and a field environment.

The control unit may include: an image processor configured to process images captured by the scanner and the cameras; a graphic processor configured to process the processed images on a monitor as at least one of the respective images, a single image, or a selected image and display the processed image; a manipulation signal determiner configured to determine a current operation state of the construction machinery by receiving the manipulation signal of the construction machinery; an obstacle determiner configured to read from the camera the surrounding image of the moving path of the construction machinery when the manipulation signal determiner determines the operation state, compare the read image with the surrounding information obtained by the scanner, check whether the surrounding information is changed, and determine an existence of an obstacle; and a control signal generator configured to receive from the operator an input signal for determining whether the detected object is the operation target or the avoidance processing target when the obstacle is detected as a result of the determination of the obstacle determiner, and filter a current value of the manipulation signal, which disables the operation of the obstacle determiner when a signal for corresponding to the operation target is generated, and which makes the corresponding operation command be automatically delayed or stopped when the construction machinery approaches the detected object when a signal corresponding to the avoidance processing object is generated.

The plurality of cameras may include a camera capturing a right-front-upper area of the construction machinery.

The control unit may make an image captured by the camera capturing the right-front-upper area be output on an entire region or at least a predetermined region of the monitor when a boom is up or a turning body turns.

The camera capturing the right-front-upper area may capture images for a right-front side of a turning body of the construction machinery, a right side having a predetermined angle with respect to the right-front side, and a 3D space at a right-upper side vertical to the right-front side and the right side.

According to the first exemplary embodiment of the present disclosure, in the construction machinery to which the AVM system is applied, the AVM screen region is displayed during a general operation, and a screen region of an upper end of the boom including a captured right-front-upper side of the turning body is selectively displayed when the boom is up or the turning body turns, thereby achieving a safety operation when the boom is up or the turning body turns to the right side in a state where the boom is up.

Further, according to the second exemplary embodiment of the present disclosure, in a case where the construction machinery moves to a place at which a surrounding geographical feature is changed in a state where the surrounding geographical feature of the construction machinery is scanned and monitored in a form of a top view based on the construction machinery, the present disclosure recognizes whether the detected object is the operation target or the avoidance processing target by sensing the detected object of the corresponding path, and stops the sensing operation when the detected object is the operation target, and makes the construction machinery be automatically controlled or move in order to prevent the construction machinery from approaching the detected object during the operation when the detected object is the avoidance processing target, thereby enhancing stability according to the operation state of the construction machinery.

However, an object of the present disclosure is not limited to the aforementioned matters, and those skilled in the art will clearly understand non-mentioned other objects through the following description.

### DESCRIPTION OF THE DRAWINGS

FIG. 1 is a configuration diagram schematically illustrating a configuration of an image display device for construction machinery according to a first exemplary embodiment of the present disclosure.

FIG. 2 is a diagram illustrating the construction machinery to which the image display device of FIG. 1 is applied.

FIG. 3 is a diagram illustrating a scope of an image captured by a right-front camera in the image display device for the construction machinery of FIG. 1.

FIG. 4 is a configuration diagram schematically illustrating a configuration of an operational stability enhancing device for construction machinery according to a second exemplary embodiment of the present disclosure.

FIG. 5 is a control flowchart illustrating a control method of construction machinery according to the operational stability enhancing device of FIG. 4.

### DETAILED DESCRIPTION

Hereinafter, an exemplary embodiment of the present disclosure will be described in detail with reference to the accompanying drawings.

### First Exemplary Embodiment

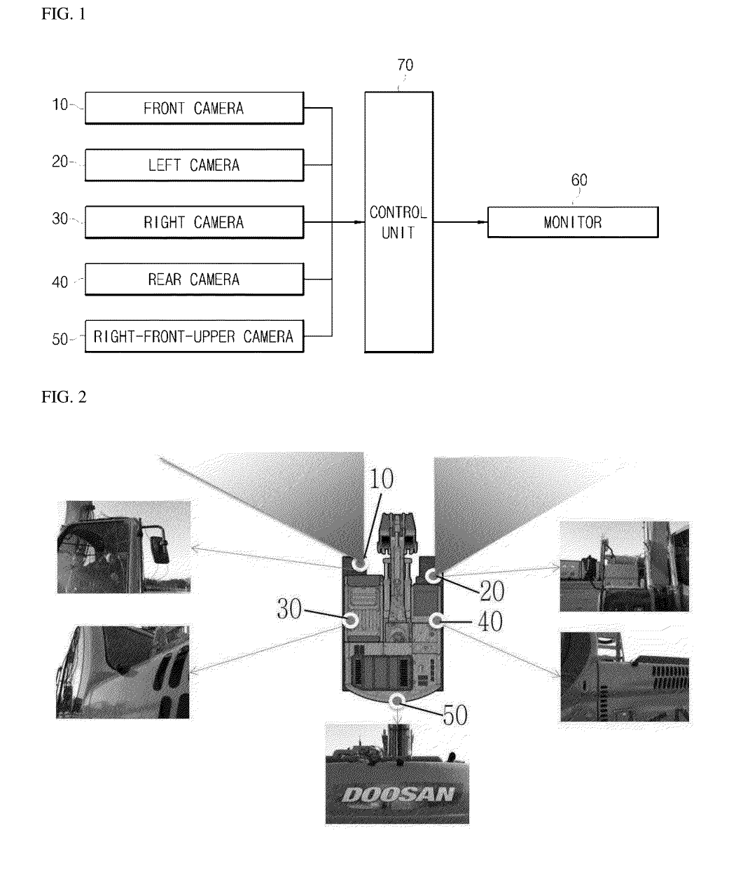

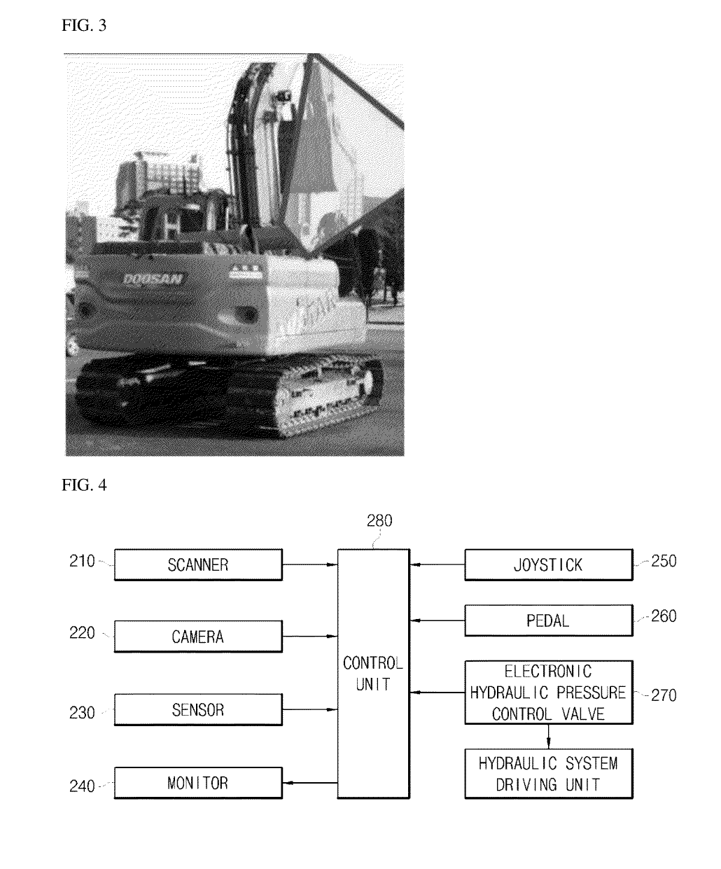

FIG. 1 is a configuration diagram schematically illustrating a configuration of an image display device for construction machinery according to a first exemplary embodiment of the present disclosure, FIG. 2 is a diagram illustrating the construction machinery to which the image display device of FIG. 1 is applied, and FIG. 3 is a diagram illustrating a scope of an image captured by a right-front camera side in the image display device for the construction machinery of FIG. 1.

As illustrated in FIGS. 1 to 3, the image display device for construction machinery according to the first exemplary embodiment of the present disclosure includes a front camera 10 positioned at a front side of a driver's cabin of the construction machinery, that is, a front side of the construction machinery, left and right cameras 20 and 30 positioned at left and right sides of the construction machinery, a front-front-upper camera 50 positioned at a right-front side of a turning body of the construction machinery to capture a right-front-upper area in a state where an AVM system, which displays an image for surrounding areas of the construction machinery in an AVM screen region through a rear camera 40 positioned at a rear side of the construction machinery is applied, a monitor 60 on which the image captured by each camera 10 to 50 is displayed in the AVM screen region and a screen region at a right-front-upper side, and a control unit 70 for processing the images captured by the cameras 10 to 50 to display the AVM screen region on the monitor 60 during a general operation, and display the right-front-upper side screen region on the monitor 60 when a boom is up or the turning body turns.

That is, in the image display device for the construction machinery according to the first exemplary embodiment of the present disclosure, the right-front-upper camera 50 is positioned at a right-front side of the turning body, to capture a predetermined space corresponding to the right-front-upper area of the turning body, so that it is possible to display the right-front-upper area hidden by the boom on a screen when the turning body turns to the right side or the boom is up.

Here, the front camera 10 of the AVM system may be positioned at a front side of the construction machinery to capture an image for a front area of the turning body. Further, the left and right cameras 20 and 30 may be positioned at a left side and a right side of the turning body of the construction machinery, respectively, to capture images for left/right-front sides based on left and right center areas of the turning body, and images for left/right-rear sides having predetermined angles with respect to the left/right-front sides. Further, the rear camera 40 may be positioned at a rear side of the turning body of the construction machinery to capture an image for a rear-left side based on a rear-center area of the turning body, and an image for a rear-right side having a predetermined angle with respect to the rear-left side.

Accordingly, in the image display device for the construction machinery, the front camera 10, the left and right cameras 20 and 30, and the rear camera 40 of the AVM system captures only an image for a three-dimensional space (lower space) from the turning body, in which the camera is positioned, to the ground, but the right-front-upper camera 50 may be positioned at the right-front area of the turning body, that is, a right side mirror of the turning body, and the like, and captures an image for a space corresponding to the right-front-upper area of the turning body.

Accordingly, according to the right-front-upper camera 50, in a state where the boom of the construction machinery is up to a high position, or in a case where the construction machinery turns to the right side, when a user cannot check the surroundings of a right-upper area of the boom due to the boom or a bucket, the right-front-upper camera 50 captures the image for the right-upper area of the boom to enable the user to check whether an obstacle, such as electric wires or a telephone pole, is positioned at the right-front-upper area of the turning body through the image when the boom is up or the turning body turns to the right side, thereby enabling the user to safely perform the turning of the turning body to the right side.

In the meantime, in the first exemplary embodiment of the present disclosure, a separate right-front-upper camera is further provided to capture an upper-front-upper side area, but when the boom is up or the turning body turns, a corresponding area may be captured by rotating some of the cameras of the AVM system.

The monitor 60 is provided inside the driver's cabin to display the images captured by the respective cameras 10 to 50 in the existing AVM screen region and the right-front-upper side screen region, and divides and displays the images according to the control of the control unit 70, or displays a combined screen region on the monitor 60 so that the right-front upper screen is positioned on a right region of the AVM screen region, or displays a corresponding image corresponding to a manipulation signal to a driver when the manipulation signal is generated from a joystick, which generates the manipulation signal for controlling an operation, such as forward travelling, backward travelling, the moving-up of the boom, and the turning, of the construction machinery.

Further, the monitor 60 may three-dimensionally display the images captured by the cameras or a surrounding image of the construction machinery from the outside according to the control of the control unit 70, and when an operation state of a constituent element of the construction machinery is changed, that is, the boom is up, an arm is dumped, or the turning body turns to the right side, the monitor 60 may automatically display the image captured by the right-front-upper camera 50 or continuously display the image captured by the right-front-upper camera 50 when the user manually selects the image.

The control unit 70 processes the images captured by the cameras 10 to 50 to display the AVM screen region on the monitor 60 during the general operation, and displays the right-front-upper side screen region on the monitor 60 when the boom is up or the turning body turns, and displays the corresponding image corresponding to the manipulation signal to the driver when the manipulation signal is generated from the joystick, which generates the manipulation signal for controlling the operation, such as forward travelling, backward travelling, the moving-up of the boom, and the turning, of the construction machinery, and includes an image processor for processing the images captured by the respective cameras to process the captured images to be displayed in to the AVM screen region, the right-front-upper side screen region, and the combined screen region in which the right-front-upper side screen is positioned in the right region of the AVM screen region, a distance calculator calculating an actual distance for the image processed by the image processor, or an actual area for the image, an information synthesizer for overlapping distance information and the image based on the information of the image processor and the distance calculator, a display unit for processing image information generated by the information synthesizer according to a predetermined image display algorithm to process and display the processed image information to the respective screen region on the monitor 60, and a manipulation signal determiner for determining a current operation state of the construction machinery by receiving the manipulation signals of the constituent elements of the construction machinery.

Here, the distance calculator calculates an actual distance to a corresponding obstacle in the captured image in a top view state by using capturing angle information, such as a focus distance, a mounting height, a vertical wide angle, and a pitch angle, and displays the calculated actual distance with dots at a predetermined interval or a number, thereby enabling the user to recognize a distance to the obstacle. That is, it is possible to calculate a distance of a corresponding image even without using a separate sensing member using ultrasonic waves, infrared rays, or laser, which detects an obstacle and calculates the distance to the obstacle.

Further, the image display algorithm may make each of the images captured by the cameras to be processed be displayed on the monitor 60, or make only an image corresponding to a corresponding operation be displayed on the monitor 60 by determining a current operation of the construction machinery by the manipulation signal determiner.

That is, for example, in a case where the image captured by each of the cameras is processed on the monitor 60 by the aforementioned processing method, and the manipulation signal determiner determines that the boom of the construction machinery is currently in an up state or the turning body is to turn to the right side in a state where the AVM screen region is displayed during the general operation, the right-front-upper side screen region captured by the right-front-upper camera 50 is separately displayed, or the combined screen region, in which the right-front-upper side screen is positioned in the right region of the AVM screen region, is displayed on the monitor 60, so that it is possible to enable the user to recognize whether an obstacle located at a corresponding space exists through the captured image for the right-front-upper area, and further, enable the user to further recognize information about an available range within which the boom is up, a distance to the obstacle, and the like.

Hereinafter, an operation and an effect of the image display device for the construction machinery according to the first exemplary embodiment of the present disclosure will be described.

In the image display device for the construction machinery according to the first exemplary embodiment of the present disclosure, the images, which are captured by the front camera 10 positioned in the driver's cabin of the construction machinery, the left and right cameras 20 and 30 positioned at the left and right sides of the construction machinery, the rear camera 40 positioned at the rear side of the construction machinery, and the right-front-upper camera 50 positioned at the right-front side of the turning body of the construction machinery, are processed by the control unit 70.

In this state, the control unit 70 determines a current operation state of the construction machinery through the manipulation signals of the constituent elements of the construction machinery, and may make the AVM screen region be displayed during the general operation of the construction machinery, and for example, in a case where the construction machinery travels, the captured image of the front camera 10 is displayed on the monitor 60 through screen conversion while the construction machinery travels forward, and the captured image of the left camera 20 is displayed on the monitor 60 through screen conversion while the construction machinery swings to the left direction.

In the meantime, in a case where it is determined that the construction machinery is in a state where the boom is currently up or the turning body plans to turn to the right side as a determination result through the manipulation signals of the constituent elements of the construction machinery, the control unit 70 makes the image captured by the right-front-upper camera 50 be displayed on the monitor 60, and in this case, information about the image captured by the right-front-upper camera 50 and displayed on the monitor 60 through screen conversion may be displayed in the combined screen region in which the right-front-upper side screen region is separately displayed from the AVM screen region, or the right-front-upper side screen region is positioned at a right portion of the AVM screen region.

In this case, the distance information within the image is also displayed in the image of the corresponding screen region, so that the user may further recognize the information, such as the available range within which the boom is up, and the distance to the obstacle, together with the existence of the obstacle located at the corresponding space of the right-front-upper area, thereby preventing a negligence accident.

Accordingly, according to the image display device for the construction machinery to which the AVM system is applied, the AVM screen region is displayed during the general operation, and the image for the right-front-upper side is selectively displayed together with the AVM screen region when the boom is up or the turning body turns to the right side, thereby enabling the user to recognize the blind spot, which is hidden by the boom, through the screen when the boom is up or the turning body turns to the right side to perform a safe operation.

### Second Exemplary Embodiment

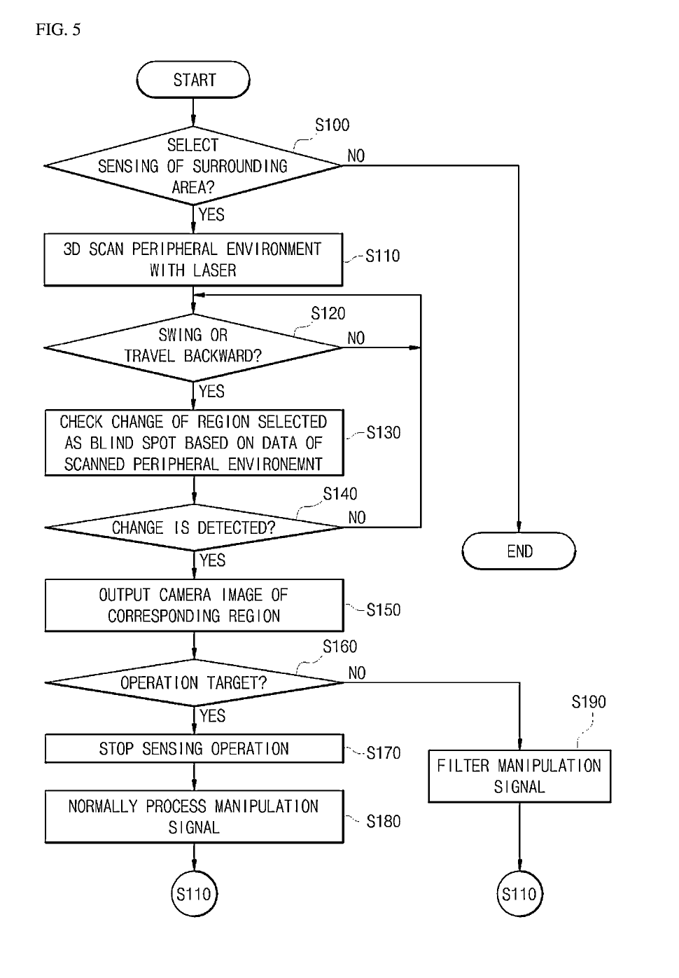

FIG. 4 is a configuration diagram schematically illustrating a configuration of an operational stability enhancing device for construction machinery according to a second exemplary embodiment of the present disclosure, and FIG. 5 is a control flowchart illustrating a control method of construction machinery according to the operational stability enhancing device of FIG. 4.

As illustrated in FIGS. 4 and 5, the operational stability enhancing device for construction machinery according to the exemplary embodiment of the present disclosure includes a scanner 210 installed at an upper side of the construction machinery and configured to three-dimensionally scan obstructions scattered in an irregular ground and a field environment, a plurality of cameras 220 provided at a front side, left and right side, a rear side, and the like of the construction machinery and configured to capture the surrounding area of the construction machinery, a plurality of sensors 230 provided at the front side, the left and right side, the rear side, and the like of the construction machinery and configured to detect an obstacle located in the surrounding area of the construction machinery, a monitor 240 configured to display surrounding information of the construction machinery scanned by the scanner 210 in a form of a top view, and displaying surrounding images of the construction machinery captured by the plurality of cameras 220, a joystick 250 and a pedal 260 configured to generate manipulation signals of a lower travelling body and an upper travelling body, and a working device performing excavation or other operation of the construction machinery, an electronic hydraulic pressure control valve 270 configured to control an output flow rate of a hydraulic system driving unit, such as a corresponding hydraulic pump and cylinder, so as to correspond to the manipulation signal of the joystick 250 and the pedal 260, and a control unit 280 electrically connected to each of the constituent elements to, when the manipulation signals of the joystick 250 and the pedal 260 are generated in a state where surrounding information obtained by the scanner 210 and surrounding information obtained by the cameras 220 are displayed on the monitor 240, that is, a travelling or turning command of the construction machinery is generated, in a case where an image for surrounding areas of a moving path corresponding to a corresponding operation command is changed or a detected object is detected in the surrounding area of the moving path by the corresponding sensor 230, recognize an operator the change in the surrounding image of the moving path or the detection of the detected object, and then stop an operation of the sensor 230 in a case where the detected object is an operation target by receiving a selection signal for determining whether the detected object is the operation target or an avoidance processing target from a separate input device, and delay or stop the corresponding operation command by automatically controlling the electronic hydraulic pressure control valve 270 when the construction machinery approaches the detected object in a case where the detected object is the avoidance processing target.

The scanner 210 is installed at the upper side of the construction machinery to 3D scan obstructions scattered in the irregular ground and the field environment, and may be formed of a laser scanning device.

Here, since the a 3D modeling system of reading the obstructions scattered in the irregular ground and the field environment through the aforementioned laser scanning device is an already publicly known technology, a detailed description will be omitted.

The plurality of cameras 220 may be formed of a left-front camera positioned at a front side of a driver's cabin of the construction machinery, that is, the left-front side of the construction machinery, left and right cameras positioned at left and right sides of the construction machinery, a rear camera positioned at a rear side of the construction machinery, and a right-front camera positioned at a right-front side of the turning body, not the driver's cabin, of the construction machinery, and the respective cameras may capture an image for a three-dimensional space from the turning body at which the camera is positioned to the ground and an upper side of the turning body.

Accordingly, the camera 220 captures a blind spot corresponding to the moving path of the construction machinery, thereby enabling the operator to check whether the obstacle exists while observing the monitor 240 in a state where the construction machinery travels or turns, or the boom is up.

The plurality of sensors 230 is provided at the front side, the left and right sides, the rear side, and the like of the construction machinery to detect the obstacle located in the surrounding area of the construction machinery, and may be a sensing member using infrared rays, ultrasonic waves, and the like, and in a case where the obstacle is located within a predetermined range of the moving path of the construction machinery, the plurality of sensors 230 enables the operator to recognize whether the obstacle exists through a buzzer, and the like.

The monitor 240 is provided inside the driver's cabin to display information about the surroundings of the construction machinery scanned by the scanner 210 in the form of a top view, and display the surrounding images of the construction machinery captured by the plurality of cameras 220, and may divide and display the respective images or display one synthesized image according to the control of the control unit 280.

The joystick 250 and the pedal 260 generate the manipulation signals of the lower travelling body and the upper travelling body, or the working device performing excavation or other operation of the construction machinery, and the electronic hydraulic pressure control valve 270 enables the construction machinery to perform a corresponding operation by controlling an output flow rate of the hydraulic pump and the cylinder according to the manipulation signal. Here, the control by the electronic hydraulic pressure control valve 270 according to the manipulation signal of the joystick 250 and the pedal 260 may be performed by an electronic control method, which is a publicly known technology, and thus a detailed description thereof will be omitted.

The control unit 280 is electrically connected to the constituent elements to perform the control of the construction machinery having stability when the manipulation signal is generated, and includes an image processor for processing the images captured by the scanner 210 and the cameras 220, a display unit for processing an image processed by the image processor according to a predetermined image display algorithm and processing and displaying the processed images on the monitor 240 as at least one of the respective images, a single image, or a selected image, a manipulation signal determiner for determining a current operation state of the construction machinery by receiving the manipulation signals of the constituent elements of the construction machinery, an obstacle determiner for reading from the camera 220 the surrounding image of the moving path of the construction machinery when the manipulation signal determiner determines the operation state, comparing the read image with the surrounding information obtained by the scanner 210, and determining that the obstacle exists in a case where the surrounding information is changed or the obstacle is detected in the surrounding area of the moving path based on a signal indicating whether the obstacle is detected, which is generated from the plurality of sensors 230, and a control signal generator for making the operator recognize the detection of the obstacle when the obstacle is detected as a result of the determination of the obstacle determiner, and receiving a signal input through an input device, that is, an input signal for determining whether the detected object (or the obstacle) is the operation target or the avoidance processing target, from the operator, and filtering a current value of the manipulation signal, which stops the operation of the sensor 230 when the signal for the operation target is generated, and which delays or stops the corresponding operation command by automatically controlling the electronic hydraulic pressure control valve 270 when the construction machines approaches the detected object when a signal for the avoidance processing object is generated.

Hereinafter, an operation and an effect of the operational stability enhancing device for the construction machinery according to the exemplary embodiment of the present disclosure will be described.

In the operational stability enhancing device for the construction machinery according to the exemplary embodiment of the present disclosure, first, when a selection signal corresponding to a sensing operation for surrounding information of the construction machinery using the scanner 210 is generated through a separate switch provided in the driver's cabin of the construction machinery or an input button on the monitor 240 (S100), the control unit 280 controls the operation of the scanner 210 to 3D scan obstructions scattered in an irregular ground and a field environment of the surrounding area of the construction machinery and then displays the 3D-scanned obstructions in a top view on the monitor (S110).

Here, the control unit 280 displays on the monitor 240 the respective surrounding images of the construction machinery captured by the plurality of cameras 220 after driving the construction machinery.

Then, the control unit 280 determines whether the manipulation signal for travelling or turning of the construction machinery is generated from the joystick 250, the pedal 260, and the like (S120).

When the manipulation signal is generated from the joystick 250, the pedal 260, and the like as a result of the determination of step S120, particularly, when the manipulation signal corresponding to the travelling backward or the turning of the construction machinery is generated, the control unit 280 compares the surrounding information scanned by the scanner 210 and an image for surrounding areas captured by a corresponding camera capturing a blind spot corresponding to the moving path of the construction machinery according to the manipulation signal so as to check whether data is changed (S130).

Then, when it is checked in step S130 that the image of the blind spot corresponding to the moving path of the construction machinery and the surrounding information scanned by the scanner 210 are changed (S140), the control unit 280 displays the surrounding image of the corresponding blind spot on the monitor 240, and make the operator recognize the change (S150).

That is, in a case where the obstacle and the like, which has not been initially scanned, exists in a direction in which the construction machinery plans to move, the control unit 280 makes the operator recognize the existence of the obstacle through the monitor, a buzzer, and the like, thereby preventing an occurrence of a negligence accident in a case where the operator does not determine whether the obstacle exists and performs the control of the construction machinery.

Then, the control unit 280 receives an input signal for determining whether the obstacle is the operation target or the avoidance processing target through a separate input device from the operator, and when the obstacle is the operation target (S160), the control unit 280 disables the obstacle sensing operation (S170), and then normally processes the manipulation signal to normally perform the operation on the obstacle (S180).

When the obstacle is the avoidance processing target in step S160, the control unit 280 continuously determines whether the construction machinery approaches the obstacle, and when it is expected that the construction machinery collides with the obstacle, the control unit 280 filters an output value corresponding to the manipulation signal and outputs the filtered output value to the electronic hydraulic pressure control valve 270, thereby preventing the obstacle and the construction machinery from colliding with each other (S190).

According to the above description, in a case where the construction machinery moves to a place at which a surrounding geographical feature is changed in a state where the surrounding geographical feature of the construction machinery is scanned and monitored in a form of a top view based on the construction machinery, the present disclosure recognizes whether the detected object is the operation target or the avoidance processing target by sensing the detected object of the corresponding path, and stops the sensing operation when the detected object is the operation target, and makes the construction machinery be automatically controlled or moved in order to prevent the construction machinery from approaching the detected object during the operation when the detected object is the avoidance processing target, thereby enhancing stability according to the operation state of the construction machinery.

The aforementioned first exemplary embodiment and second exemplary embodiment may be combined with each other. In the combination thereof, the constituent elements of the first exemplary embodiment and the constituent elements of the second exemplary embodiment are not all essentially required, and some of the constituent elements may be omitted.

Although the exemplary embodiments of the present disclosure have been described with reference to accompanying drawings, those skilled in the art will appreciate that various modifications, additions and substitutions are possible, without departing from the scope of the technical spirit or the essential feature of the disclosure, so that the exemplary embodiments may be implemented to other particular forms. Therefore, the aforementioned exemplary embodiments are all illustrative and are not restricted to a limited form.

1. An operational stability enhancing device for construction machinery, comprising:
a plurality of cameras configured to capture surrounding images of construction machinery;
a plurality of sensors configured to detect an obstacle located in a surrounding area of the construction machinery;
a monitor configured to display the surrounding images of the construction machinery captured by the plurality of cameras;
an electronic hydraulic pressure control valve configured to control an output flow rate of a corresponding hydraulic system driving unit so as to correspond to a manipulation signal of a user manipulation unit of the construction machinery; and
a control unit configured to, in a case where a detected object is detected in a surrounding area of a moving path by the sensor, and the detected object is an avoidance processing target, display an image of the captured detected object on a monitor through screen conversion or change the image of the captured detected object when the construction machinery approaches the detected object.

2. The operational stability enhancing device of claim 1, wherein in a case where the detected object is an avoidance processing target, the control unit delays or stops an operation command for the manipulation signal by automatically controlling the electronic hydraulic pressure control valve when the construction machinery approaches the detected object.

3. The operational stability enhancing device of claim 1, further comprising:
a scanner configured to scan surrounding information of the construction machinery.

4. The operational stability enhancing device of claim 3, wherein the scanner is installed at an upper side of the construction machinery to 3D scan obstructions scattered in an irregular ground and a field environment.

5. The operational stability enhancing device of claim 3, wherein the control unit includes:
an image processor configured to process images captured by the scanner and the cameras;
a graphic processor configured to process the processed images on a monitor as at least one of the respective images, a single image, or a selected image and display the processed image;
a manipulation signal determiner configured to determine a current operation state of the construction machinery by receiving the manipulation signal of the construction machinery;
an obstacle determiner configured to read from the camera the surrounding image of the moving path of the construction machinery when the manipulation signal determiner determines the operation state, compare the read image with the surrounding information obtained by the scanner, check whether the surrounding information is changed, and determine an existence of the obstacle; and
a control signal generator configured to receive from the operator an input signal for determining whether the detected object is an operation target or the avoidance processing target when the obstacle is detected as a result of the determination of the obstacle determiner, and filter a current value of the manipulation signal, which disables the operation of the obstacle determiner when a signal corresponding to the operation target is generated, and which makes the corresponding operation command be automatically delayed or stopped when the construction machinery approaches the detected object when a signal corresponding to the avoidance processing object is generated.

6. The operational stability enhancing device of claim 1, wherein the plurality of cameras includes a camera capturing a right-front-upper area of the construction machinery.

7. The operational stability enhancing device of claim 6, wherein the control unit makes an image captured by the camera capturing the right-front-upper area be output on an entire region or at least a predetermined region of the monitor when a boom is up or a turning body turns.

8. The operational stability enhancing device of claim 6, wherein the camera capturing the right-front-upper area captures images for a right-front side of the turning body of the construction machinery, a right side having a predetermined angle with respect to the right-front side, and a 3D space at a right-upper side vertical to the right-front side and the right side.

9. The operational stability enhancing device of claim 1, wherein the image of the captured detected object is changed by selecting at least one of a method of making the corresponding image flicker, a method of displaying a screen image with a different color, and a method of displaying the corresponding image on the entire monitor or displaying the corresponding image at a center portion of the monitor in a pop-up form in a case where the corresponding image is displayed on one screen among the plurality of screens.
